(19) United States
(12) Patent Application Publication
(10) Pub. No.: US 2004/0192863 A1
(43) Pub. Date: Sep. 30, 2004

(54) Catalyst activation method and activated catalyst

(76) Inventor: Thomas W. Towles, Baton Rouge, LA (US)

Correspondence Address: ExxonMobil Chemical Company, Law Technology, P.O. Box 2149, Baytown, TX, 77522-2149, US

(21) Appl. No.: 10/784,380

(22) Filed: Feb. 23, 2004

(30) Foreign Application Priority Data
Mar. 31, 2003 (WO) PCT/US03/09871

(51) Int. Cl. C08F 4/06; B01J 23/26

(52) U.S. Cl. 526/113; 502/309

(57) ABSTRACT

The present invention relates to the removal of hydrocarbon residues from a catalyst and more specifically the air activation of a catalyst containing hydrocarbon residues

### CROSS-REFERENCE TO RELATED APPLICATIONS

The present application claims the benefit of International Application No. PCT/US03/09871, filed Mar. 31, 2003, said application incorporated herein by reference.

### FIELD OF THE INVENTION

The present invention relates to the removal of hydrocarbon residues from a catalyst and more specifically the activation of a catalyst containing hydrocarbon residues.

### BACKGROUND

Components of a catalyst are often supplied to a support by contacting the support with a solution containing the component, such as for instance contacting a silica support with a solution of chromium acetate in hexane. See, for example, U.S. Pat. No. 5,895,770.

It is well known in the art to activate a supported catalyst comprising chromium, useful in the manufacture of polyolefins such as polyethylene, by a treatment comprising calcining the supported catalyst in the presence of an excess of molecular oxygen at a temperature in the range of about 300° C. to about 1000° C. for up to about 50 hours. See, for example, U.S. Pat. No. 4,981,831.

U.S. Pat. No. 5,093,300 discloses that after treatment in an oxidizing atmosphere up to about 850° C. a chromium catalyst is cooled down and then treated in a non-oxidizing atmosphere.

U.S. Pat. No. 6,150,572 discloses regenerating a chromium catalyst containing organic contaminants by treatment with an oxidizing gas such as air at temperatures of from 350° C. to 400° C. until the organic contaminants disappear, followed by treatment with hydrogen mixed with an inert gas.

U.S. Pat. No. 6,201,077 B1 discloses a chromium on silica catalyst activated in an oxidizing ambient at from 600-1100° F. (about 315° C. to about 590° C.) useful in producing a polyethylene having high ESCR for blow molding applications. The activation treatment period is from 1 minute to 50 hours. The most preferred activation temperature is from about 900° F. to about 1050° F. (about 480° C. to about 565° C.). U.S. Pat. No. 6,204,346 and U.S. patent application Ser. Nos. 2001/0004663 and 2001/0007894 disclose similar procedures.

U.S. Pat. No. 6,214,947 discloses treating a chromium catalyst in a dry inert gas, then titanating the catalyst, and then activating with oxygen. U.S. Pat. No. 6,359,085 (see also the related EP 1038 886 A1) discloses a thermal treatment for a chromium-based catalyst comprising treatment under N₂ at 350-850° C. and then treatment under air at 350-850° C. The treatment with both nitrogen and air preferably occurs at or above 480° C., but according to the disclosure the treatment in nitrogen and air must not be carried out at the same temperature and it is preferred that the treatment in air occur at a temperature lower than the treatment under N₂. After the treatment with air, the chromium-based catalyst is cooled down to room temperature while replacing the air with nitrogen before contact with ethylene in a polymerization process.

EP 0 882 740 A1 and EP 0 882 743 A1 disclose a supported chromium-based catalyst titanated under specific conditions and used for the homopolymerization or copolymerization of ethylene. After drying in an inert gas at a temperature of at least 300° C., the catalyst is titanated and then activated at a temperature of at least 500° C.

The present inventor has observed that catalysts comprising a support such as silica which is coated with chromium, titanium and optionally at least one of zirconium, aluminum, and boron, and containing organic residues from the coating process, produce a heat kick or temperature spike during normal air activation, such as by heated fluidization. While not wishing to be bound by theory, this heat kick is believed to be the result of uncontrolled oxidation of the organic groups. The present inventor has discovered that controlling the temperature spike in the appropriate manner improves the catalyst performance, as hereinafter described.

Embodiments of the present invention may have the advantage over previously known methods of activating supported chromium/titanium catalysts in having one or more of the following: an improved catalyst activity, improved MI (melt index) response, an improved ESCR (Environmental Stress Crack Resistance) in a polyethylene manufactured using the catalyst prepared according to the present invention, or a combination of these improvements. The catalyst prepared according to the invention may be used to produce polyolefins by solution polymerization, slurry polymerization, and gas-phase polymerization techniques.

### SUMMARY OF THE INVENTION

The present invention relates to an activation procedure for a supported catalyst comprising chromium and titanium which utilizes nitrogen or other inert gas in the early stages of the activation, followed by controlled addition of an oxidant, such as oxygen gas, preferably air, to complete the activation of the catalyst. In one embodiment, the present invention includes treatment of a chromium and titanium-based supported catalyst in a reactor at about 370-540° C. (700-1000° F.), preferably 370-450° C. (700-850° F.), more preferably 370-425° C. (700-800° F.), still more preferably 370 to 400° C. (700-750° F.), under an inert atmosphere, followed by the introduction of oxygen gas and controlling the reactor temperature so that the temperature of the catalyst reactor does not exceed 510° C. (950° F.), preferably no higher than about 480° C. (900° F.), and yet still more preferably no higher than about 450° C. (850° F.), most preferably no higher than about 425° C. (800° F.).

In another embodiment the reactor temperature is controlled by the rate of addition of oxygen and by the temperature of the gas entering the reactor. Thus, the present invention also includes treating a chromium and titanium-containing supported catalyst at about 370-400° C. (700-750° F.) under an inert atmosphere which may be at least partially preheated to a temperature higher or lower than the reactor temperature, followed by the controlled introduction of an oxidant, preferably in the form of air, which has been preheated to a temperature no greater than about 400° C. (750° F.), most preferably by air which has been preheated to about 200° C. (400° F.) or less, while controlling the temperature spike so that the temperature of the catalyst reactor does not exceed 510° C. (950° F.), preferably no higher than about 480° C. (900° F.), and yet still more preferably no higher than about 450° C. (850° F.), most preferably no higher than about 425° C. (800° F.). Activation may then be completed by contacting the catalyst in the reactor with an oxidizing atmosphere, preferably an atmosphere consisting essentially of air. It is preferred that the final temperature of the reactor under an atmosphere consisting essentially of air be at least about 425° C. (800° F.), more preferably about 540° C. (1000° F.), and still more preferably 590° C. (1100° F.) up to about 870° C. (1600° F.). Yet another embodiment includes the supported chromium and titanium-containing catalyst produced by the process according to the present invention, which is useful in the manufacture of polyolefins having improvements in one or more of the following properties: activity, MI (melt index) response, and ESCR (Environmental Stress Crack Resistance).

These and other embodiment, features, and advantages of the present invention will become apparent as reference is made below to a detailed description of additional embodiments, including specific examples.

### DETAILED DESCRIPTION

The catalyst treated by the process according to the present invention comprises chromium and titanium on a support. In order to achieve the maximum advantages provided by the present invention, the supported catalyst further comprises hydrocarbon residues, as described more fully below. In one embodiment the catalyst is supported on silica. In another embodiment a silica/alumina support is used.

The chromium and titanium catalyst may further comprise at least one of zirconium, aluminum, or boron. In a preferred embodiment the catalyst is a silica-supported thermally-activated chromium and titanium catalyst.

In an embodiment described herein, the chromium and titanium-based supported catalyst to be treated by the method described herein has hydrocarbon residues deposited thereon. “Hydrocarbon residues” as used herein means any species or moiety containing hydrogen and carbon, which is present on the catalyst and/or support. Without limitation, such hydrocarbon residues may be present on the catalyst and/or support as a result of having been deposited during the manufacture of the catalyst or support, such as organic solvent residues or by the deposition of one or more of chromium, titanium, zirconium, aluminum, and boron on the support from an organic solution (e.g., chromium acetate), such as described in the previously mentioned U.S Pat. No. 5,895,770. Hydrocarbon residues may also be present in supported catalysts comprising chromium and/or titanium made by gel processes such as in the cogel and tergel catalysts described in the previously mentioned EP patents. The present invention is applicable to any chromium and titanium-based supported catalyst having hydrocarbon residues thereon or therein, however made.

As used herein, the terms “chromium and titanium-based supported catalyst” will refer to the aforementioned embodiments wherein the supported catalyst comprises chromium and titanium and optionally at least one of zirconium, aluminum, or boron. This term is intended to distinguish the catalyst according to the present invention from a “chromium-based catalyst” which does not contain titanium.

In a preferred embodiment of the invention, the process concerns the activation of catalyst, where the catalyst is a chromium and titanium-based supported catalyst supported on silica or silica/alumina, optionally further comprising zirconium, boron, aluminum, and mixtures thereof, wherein the chromium and titanium and optional species, if present, have been deposited from solution prior to the treatment according to the present invention, and hydrocarbon residues are present at least in part as a result of this deposition process (e.g., it may be from the solvent or metal counter ion). Hydrocarbon residues may also be present as a result of the manufacture or processing of the support.

Appropriate supported titanium-chromium catalysts are commercially available or they can be made by one of ordinary skill in the art. Examples of suitable, commercially available titanium-chromium catalysts include titanium-surface modified chromium catalysts from PQ Corporation, Philadelphia, Pa., such as C-23307, C-25305, C-25345, C-23305, and C-25307.

The supported catalyst comprising chromium and titanium and optionally one or more of zirconium, boron, and aluminum, is then placed in an activator or reactor to be treated by the process according to the present invention. The terms “activator” and “reactor” are used interchangeably herein for convenience. The invention may be practiced using any known method for bringing gases and solids into contact with each other, such as in a static bed or a fluidizing bed. Advantageously the reactor will be a fluidized bed reactor.

The reactor may be heated by, for instance, internal reactor heating rods, by an external source of heat applied to the reactor walls, such as electrical heat or by heat of combustion, by provision for heating the gas entering the reactor via one or more gas inlet valves, or by a combination of such heating sources, all of which can be measured and controlled by means per se well known.

It should be noted that, as used herein, “reactor temperature” is typically measured at or very close to the catalyst bed and thus, as would be understood by one of skill in the art, “reactor temperature” is taken as surrogate for the temperature of the catalyst.

In a previously known process for the activation of a supported chromium and titanium catalyst for the polymerization of polyolefins, the catalyst is activated by oxygen gas, typically provided in the form of dry (anhydrous) air, at elevated temperatures. The temperature is ramped up from room temperature to about 425° C. to about 870° C. (800-1600° F.) using, for instance, a combination of reactor heating rods and gas inlet preheaters. However, during this air activation process a very large temperature spike is observed early during ramping, well below the point at which the reactor temperature is at about 370° C. (700° F.), which rapidly brings the reactor temperature to above 590° C. (1100° F.) for a few minutes. The reactor temperature then subsides until it achieves a temperature consistent with the temperature ramp of the activation procedure.

According to an embodiment of the present invention, similar to the above procedure but using dry (anhydrous) nitrogen gas, argon, or other inert gas, the temperature of the fluidized bed reactor is ramped from room temperature to a preselected temperature between about 370-540° C. (700-1000° F.), preferably 370-450° C. (700-850° F.), more preferably 370-425° C. (700-800° F.), still more preferably (700-750° F.), for a hold period, preferably at least for a time sufficient for most if not all the water, along with a substantial portion of the hydrocarbon residues, to be driven off from the supported catalyst. This temperature hold under nitrogen or other inert environment is preferably held for one minute to up to 6 hours.

In another embodiment of the invention, in addition to the temperature hold period described above, additional hold periods at temperatures lower than 370° C. (700° F.) are contemplated. Thus in one embodiment the reactor temperature is ramped up from room temperature to about 205° C.±25° C. (400° F.±45° F.) at about 220° C./hr (400F/hr) and held at this temperature under a nitrogen atmosphere for a period of one minute to up to about 6 hours, or even more, followed by a temperature ramp up to a preselected temperature between about 370-540° C. (700-1000° F.), preferably 370-450° C. (700-850° F.), more preferably 370-425° C. (700-800° F.), still more preferably 370 to 400° C. (700-750° F.), at a rate of about 200° C./hr (350° F./hr), while still under an inert atmosphere. This temperature and inert atmosphere is then held constant for a period of from one minute up to about 6 hours. Even greater hold periods are possible, however the benefits, if any, are generally offset by the greater cost.

According to an embodiment of the invention the reactor temperature of between about 370-540° C. (700-1000° F.), preferably 370-450° C. (700-850° F.), more preferably 370-425° C. (700-800° F.), still more preferably 370 to 400° C. (700-750° F.), is held, as mentioned, for a period before continuing the temperature ramping and/or changing the treatment gas from entirely nitrogen (or other inert gas) to at least partial oxygen, as further described below.

The temperature hold periods described above may be selected to be any time within the time ranges specified. Thus, the present invention contemplates embodiments wherein the temperature is held at a preselected temperature between about 370-540° C. (700-1000° F.), preferably 370-450° C. (700-850° F.), more preferably 370-425° C. (700-800° F.), still more preferably 370 to 400° C. (700-750° F.), for any period between 1 minute to up to six hours or more, such as for a period of one hour, a period of from one hour for up to two hours, a period of from two hours for up to three hours, a period of from three hours for up to four hours, a period of from four hours for up to five hours, a period of from one hour to five hours, or any period of time within the aforementioned ranges, prior to changing the temperature conditions of the reactor, and/or prior to changing the atmosphere of the reactor, as described in more detail herein.

In another embodiment, the reactor includes both reactor heater rods and gas inlet preheaters, and both are used during ramping and during the temperature hold periods. In an embodiment, however, the temperatures of the reactor and the gas inlet preheaters are not identical. Thus, in one preferred embodiment during the hold period the one or more gas inlet preheaters heat the entering inert gas to a temperature of about 450° C. (850° C.) while the reactor heating rods are allowed to adjust to a temperature which will allow the reactor temperature to be maintained at the selected temperature within the range of 370-540° C. (700-1000° F.), preferably 370-450° C. (700-850° F.), more preferably 370-425° C. (700-800° F.), still more preferably 370 to 400° C. (700-750° F.).

In another embodiment, after a certain period of time at the hold temperature of 370-540° C. (700-1000° F.), preferably 370-450° C. (700-850° F.), more preferably 370-425° C. (700-800° F.), still more preferably 370 to 400° C. (700-750° F.), and prior to a change over to a partial oxidizing atmosphere, the temperature of the gas inlet preheater(s) is lowered to a temperature below the reactor temperature. Thus, in one embodiment the temperature of the gas inlet preheater(s) is lowered to about 400° C. or less or in yet another embodiment it is lowered still further to as low as about 200° C. or less. In these embodiments wherein the entering gas effectively provides a coolant to the reactor, the reactor heating rods (or external heating source) must provide additional heat to maintain the temperature of the reactor constant.

The nitrogen (or inert gas) treatment may occur to an even higher temperature, however (again without wishing to be bound by theory) it is believed that above about 540° C. (1000° F.) the supported chromium and titanium catalyst may be converted partially or wholly into a form (“green batch”) which is less amenable to a subsequent treatment with oxygen. A green batch may also be observed under conditions where the oxygen is present at a concentration of less than about 20% by volume, i.e., less oxygen than is normally present in air. Thus temperatures of above about 540° C. should be avoided during the treatment under pure nitrogen or other inert gaseous treatment and during conditions where pure nitrogen is mixed with air.

After the aforementioned treatment under nitrogen according to the present invention, oxidant may be introduced into the reactor, preferably oxygen gas, and more preferably air. It is preferred that the temperature of the reactor be between about 370-425° C. (700-800° F.), preferably about 370 to 400° C. (700-750° F.), most preferably at about 400° C. (750° F.).

Preferably oxygen is introduced into the reactor by adding a small amount of air to the gas inlet mixture. In an embodiment of the invention the addition of air is controlled so that the observed temperature spike does not exceed 590° C. (1100° F.), more preferably 480° C. (900° F.), even more preferably 450° C. (850° F.) and yet still more preferably the temperature spike does not exceed 425° C. (800° F.).

In a preferred embodiment, a 370-400° C. (700-750° F.) nitrogen atmosphere temperature hold is maintained for about 3.5 hours and then air is introduced in with the nitrogen flow so that the gas entering through the gas inlet(s) consists of about 2.8% oxygen. This atmosphere is maintained for about 1.5 hours, while controlling the reactor temperature so that the observed temperature spike does not exceed 590° C. (1100° F.), more preferably 480° C. (900° F.), even more preferably 450° C. (850° F.) and yet still more preferably does not exceed 425° C. (800° F.).

The total gas flow rate preferably is maintained at a constant rate during the change over from nitrogen to oxygen, so that the increase in oxygen to the desired partial pressure is accompanied by a decrease in the nitrogen partial pressure. As previously described, at some point prior to the introduction of a partial atmosphere of oxygen, in a preferred embodiment the gas entering the reactor via the inlet valve(s) effectively provides a coolant to the reactor by lowering the temperature of the inlet preheaters to as low as 400° C. or less or even as low as about 200° C. or less. In a preferred embodiment this lowered temperature of the preheater is maintained during the introduction of a partial air environment.

Even after the treatment for a prolonged period under nitrogen, a temperature spike is observed when even a small amount of oxygen is first admitted to the reactor. However, in accordance with the present invention the observed temperature spike may be controlled to no greater than 480° C. (900° F.), more preferably no greater than 450° C. (850° F.) and yet still more preferably no greater than 425° C. (800° F.).

After the temperature spike subsides and the reactor temperature approaches the preselected temperature within the range of 370-540° C. (700-1000° F.), preferably 370-450° C. (700-850° F.), more preferably 370-425° C. (700-800° F.), still more preferably 370 to 400° C. (700-750° F.), the atmosphere may be converted to 100% air and the temperature may be ramped up to the final treatment temperature.

Activation may then be completed, preferably by contacting the catalyst in the reactor with an oxidizing atmosphere, preferably an atmosphere consisting essentially of air. It is more preferred that the final temperature of the reactor under an atmosphere consisting essentially of air be at least about 425° C. (800° F.), more preferably about 540° C. (1000° F.), and still more preferably 590° C. (1100° F.) up to about 870° C. (1600° F.). In a preferred embodiment the temperature is ramped up to the final hold temperature at about 65° C./hr (150° F./hr). In a preferred embodiment, the final temperature may be held for a period of time of from 1 minute up to about 6 hours or even longer. More preferably the final temperature hold the the temperature of between 425° C. (800° F.) and 870° C. (1600° F.) is between 4 hours and 6 hours.

The thus-activated supported chromium and titanium-based catalyst, optionally containing one or more of zirconium, aluminium, and boron, is then preferably cooled to about 150-315° C. (300-600° F.), purged with nitrogen while cooling to room temperature and then used as desired.

Reference will be made to the following specific example, which is not intended to be limiting.

### EXAMPLE 1

A silica-supported chromium and titanium-based catalyst activation was performed on a commercially available catalyst, PQ C-25307™, available from PQ Catalyst Corporation, Philadelphia, Pa.

The catalyst is placed in a fluidizing bed reactor of the type well-known in the art. The reactor comprises heating rods to heat the catalyst bed and gas inlets with preheaters. The catalyst is fluidized with dry N₂ and the temperature of the reactor/catalyst bed is ramped up at about 222° C./hr (400° F./hr) to 205° C. (400° F.).

It is held at this temperature under a nitrogen flow of about 126 CFM (cubic feet per minute) for 4 hours and then ramped at about 195° C./hr (350° F./hr) to a hold at about 400° C. (750° F.) under a nitrogen flow of about 144 CFM. The catalyst is held in the reactor under these conditions for about 3.5 hours. The gas inlet preheaters are set to 450° C. (850° F.) during the period that the reactor temperature is held at 400° C. (750° F.) under nitrogen, and shortly before the introduction of the 20 CFM of air, the gas inlet preheaters are lowered to about 200° C. (400° F.).

Then a controlled amount of oxidant, in the form of dry air at a rate of 20 CFM, with a decrease in the nitrogen flow to approximately 122 CFM, so that the amount of oxygen in the reactor is at a concentration of about 2.8% by volume, while maintaining the reactor at about 400° C. (750° F.). A temperature spike to about 425° C. (800° F.) is observed in the reactor shortly after the partial oxygen environment is introduced, but the reactor temperature approaches 400° C. (750° F.) within about 90 minutes. The gas inlet preheaters remain set at about 200° C. (400° F.) during this period.

The atmosphere is then switched to 100% dry air and the temperature is ramped using both the reactor probe heaters and the gas inlet preheaters, at about 83° C. (150° F./hr) to a 6 hour hold at 650° C. (1200° F.) and held for 6 hours, when activation is complete.

The catalyst is then cooled to about 150-205° C. (300-400° F.) under an atmosphere of air and then fluidized with nitrogen and allowed to come to room temperature. The thus-activated catalyst is used in a slurry loop polymerization process to produce HDPE resin.

The resin has a Melt Index (190/2.16) of 0.30 g/10 min (ASTM D-1238), Density of 0.946 g/cm³ (ASTM D-4883), and ESCR >96 hours (ASTM D-1693, Condition B, F20, 10% Igepal). This resin is particularly suitable for telecommunications conduit pipe (although the aforementioned values should not be interpreted as specifications therefor).

Trade names used herein are indicated by a ™ symbol, indicating that the names may be protected by certain trademark rights. Some such names may also be registered trademarks in various jurisdictions.

All patents and patent applications, test procedures (such as ASTM methods), and other documents cited herein are fully incorporated by reference to the extent such disclosure is not inconsistent with this invention and for all jurisdictions in which such incorporation is permitted.

All temperatures were measured using ° F. scale and thus some additional tolerance should be allowed for rounding during conversion of these temperatures to ° C. scale, in addition to the ordinary tolerance provided for the term “about”.

When numerical lower limits and numerical upper limits are listed herein, ranges from any lower limit to any upper limit are contemplated.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

Many variations will suggest themselves to those skilled in this art in light of the above detailed description. All such obvious modifications and are within the full intended scope of the appended claims as well as the following embodiments: a process for the activation of a supported catalyst comprising chromium and titanium, said process comprising: (a) contacting said catalyst in a reactor at a temperature of between about 370-540° C. (700-1000° F.), preferably 370-450° C. (700-850° F.), more preferably 370-425° C. (700-800° F.), still more preferably 370 to 400° C. (700-750° F.) with an atmosphere consisting essentially of an inert gas; and then (b) introducing an oxidant, preferably air, into said reactor so that the temperature of said reactor does not exceed about 510° C. (950° F.), preferably does not exceed about 480° C. (900° F.), and yet still more preferably does not exceed 450° C. (850° F.), most preferably does not exceed about 425° C. (800° F.); and then (c) completing the activation of said catalyst; and the aforementioned process wherein step (c) further comprises contacting said catalyst in said reactor with an atmosphere consisting essentially of air, preferably for at least one minute, more preferably for a period of from 1 minute to about 6 hours; and any of the above wherein step (c) further comprises contacting said catalyst in said reactor with an atmosphere consisting essentially of air between about 425° C. (800° F.) and about 870° C. (1600° F.); and any of the above wherein the temperature of the reactor in (a) does not exceed about 400° C. (750° F.), and the temperature of said reactor in (b) does not exceed about 425° C. (800° F.); and any of the above wherein said oxidant is air; and any of the above wherein both (a) and (b) include a step wherein the gases introduced into the reactor are preheated to a temperature of about 400° C. or less; and any of the above wherein both (a) and (b) include a step wherein the gases introduced into the reactor is preheated to a temperature of about 200° C. or less; and any of the above wherein said supported catalyst further comprises a metal selected from the group consisting of zirconium, aluminium, boron, and mixtures thereof, and any of the above wherein said supported catalyst comprises chromium and titanium supported on silica; and any of the above wherein said supported catalyst comprises chromium and titanium supported on silica-alumina; and any of the above wherein (b) includes controlling the reactor temperature by controlling the amount of oxidant input into the reactor; and any of the above wherein (b) includes controlling the reactor temperature by controlling the temperature of the air input into the reactor; and any of the above wherein (b) includes controlling the reactor temperature by controlling the amount of the air input into the reactor and controlling the temperature of the air input into the reactor; and any of the above wherein (a) includes a step wherein the inert gas introduced into the reactor is preheated to a temperature of about 450° C. (850° F.) and then a step wherein said inert gas is preheated to a temperature of no more than 200° C. (400° F.); and any of the above wherein said catalyst further comprises hydrocarbon residues present on the support as a result of the deposition of chromium and titanium from solution; and also including a supported chromium and titanium-based catalyst, optionally further comprising at least one of aluminum, boron, and zirconium, activated by the process according to any of the embodiments set forth above; and also including a polyethylene comprising the residue of a catalyst activated according to any of the process embodiments set forth above, or a polyethylene comprising the residue of the chromium and titanium-based catalyst characterized above; and also including an article comprising polyethylene characterized above.

I claim:

1. A process for the activation of a supported catalyst comprising a support, chromium and titanium, said process comprising:
(a) contacting said catalyst in a reactor at a temperature of between about 370-540° C. (700-1000° F.) with an atmosphere consisting essentially of an inert gas; and then
(b) introducing an oxidant into said reactor so that the temperature of said reactor does not exceed about 510° C. (950° F.), and then
(c) completing the activation of said catalyst; and
(d) obtaining said catalyst.

2. The process according to claim 1, wherein step (c) further comprises contacting said catalyst in said reactor with an atmosphere consisting essentially of air.

3. The process according to claim 2, wherein step (c) further comprises contacting said catalyst in said reactor with an atmosphere consisting essentially of air between about 425° C. (800° F.) and about 870° C. (1600° F.).

4. The process according to claim 1, wherein the temperature of the reactor in (a) does not exceed about 400° C. (750° F.), and the temperature of said reactor in (b) does not exceed about 425° C. (800° F.).

5. The process according to claim 1, wherein said oxidant is air.

6. The process according to claim 5, wherein both (a) and (b) include a step wherein the gases introduced into the reactor are preheated to a temperature of about 400° C. or less.

7. The process according to claim 6, wherein both (a) and (b) include a step wherein the gases introduced into the reactor is preheated to a temperature of about 200° C. or less.

8. The process according to claim 1, wherein said supported catalyst further comprises a metal selected from the group consisting of zirconium, aluminium, boron, and mixtures thereof.

9. The process according to claim 1, wherein said support is silica.

10. The process according to claim 1, wherein said support is silica-alumina.

11. The process according to claim 1, wherein (b) includes controlling the reactor temperature by controlling the amount of oxidant introduced into the reactor.

12. The process according to claim 5, wherein (b) includes controlling the reactor temperature by controlling the temperature of the air introduced into the reactor.

13. The process according to claim 5, wherein (b) includes controlling the reactor temperature by controlling the amount of the air introduced into the reactor and controlling the temperature of the air introduced into the reactor.

14. The process according to claim 5, wherein in (a) the inert gas is preheated to a temperature of about 450° C. (850° F.) and then is preheated to a temperature of no more than 200° C. (400° F.).

15. The process according to claim 1, wherein said catalyst further comprises hydrocarbon residues present on the support as a result of the deposition of chromium and titanium thereon from solution.

16. A supported chromium and titanium-based catalyst, optionally further comprising at least one of aluminum, boron, and zirconium, activated by the process according to claim 1.

17. A polyethylene comprising the residue of a catalyst activated according to the process of claim 1.

18. An article comprising polyethylene according to claim 17.
